(19) United States
(12) Patent Application Publication
(10) Pub. No.: US 2024/0221501 A1
(43) Pub. Date: Jul. 4, 2024

(54) EMERGENCY ALERT SYSTEM

(71) Applicant: Jeryes Keshek, San Jose, CA (US)

(72) Inventor: Jeryes Keshek, San Jose, CA (US)

(21) Appl. No.: 18/092,313

(22) Filed: Dec. 31, 2022

(51) Int. Cl. G08G 1/087; G08B 27/00; H04W 64/00; H04W 76/50

(52) U.S. Cl. CPC G08G 1/087; G08B 27/001; H04W 64/003; H04W 76/50

(57) ABSTRACT

An emergency alert system includes a controller; a communication interface; and a memory, coupled to the controller and the communication interface, the memory including modules that when executed by the controller, cause the emergency alert system: receive real-time location information from one or more emergency vehicles; determine a route to be traversed by the one or more emergency vehicles; receive location information from one or more non-emergency vehicles; determine the location of the one or more emergency vehicles and the one or more non-emergency vehicles intersect and send a warning signal to at least one of the one or more emergency vehicles and the at least one or more non-emergency vehicles.

### FIELD OF THE INVENTION

The present invention generally relates to information technology and, more particularly, to a real-time vehicle emergency alert system.

### BACKGROUND OF THE INVENTION

Between 1992 and 1997, 114 Emergency Medical Technicians and Paramedics were killed in the line of duty; more than half resulting from ambulance crashes. Of the 114 deaths, 67 were from ground transportation accidents; 19 from air ambulance crashes; 13 from heart attacks, strokes and other cardiovascular events; 10 from homicides, most of them shootings; and 5 from other causes, such as needlesticks, electrocution and drowning.

Federal Emergency Management Agency (FEMA) found firefighters are more likely to die in a motor vehicle crash than while fighting a fire. Crashes were the leading cause of death for police officers in 11 out of the 12 years prior to 2014. Most firefighters worry less about running into a burning building and more about trying to get to the call for help. Some first responders wish there was some sort of nationwide educational program to teach—or re-teach—drivers how to behave when there is an emergency vehicle approaching.

Conventional emergency dispatch systems and emergency response times are often ineffective for one or more of the following reasons: (1) drivers often do not see the lights and/or do not hear the sirens of emergency vehicles: (2) drivers are listening to the radio, eating, texting or talking on cell phones; (3) emergency vehicles are big and cannot maneuver very well, they need room to turn, and they don't stop that well; (4) sirens have become more commonplace. A few decades ago, people took notice when they heard the blare of an emergency vehicle coming. Now, the frequency of sirens is so great, the sound can seem like just background noise; and (5) cars are more soundproof now, as such, drivers just don't notice other vehicles on the road despite the sirens and lights present on most emergency vehicles.

Thus, there is a need for an effective emergency alert system to alert motorists and provide instructions regarding the presence of an oncoming vehicle, particularly an emergency vehicle.

### SUMMARY OF THE INVENTION

An emergency alert system (EAS) includes a controller configured to execute instructions. The EAS also includes a communication interface configured to send and receive location and other emergency information to a vehicle in the path of or in close proximity to an emergency event. The EAS also includes a memory which is coupled to the controller and the communication interface. The memory including modules that when executed by the controller, cause the EAS to: (1) receive real-time location information from one or more vehicles; (2) determine a route to be traversed by the one or more vehicles; (3) receive location information from a second vehicles; (4) determine an intercept location of the first and second vehicles; and (4) send a warning signal to at least one of the two vehicles.

A feature of the present invention is that it causes at least one or more of the vehicles to hang up an ongoing phone call or put the phone on pause, such as with Bluetooth.

Another feature of the present invention is that is provides an audio or visual message to the driver who may be driving behind or in front of an emergency vehicles to change lanes or slow down to avoid rear-ending the emergency vehicle.

A benefit provided by the EAS is that it may help people at intersection where there is no traffic light to determine the right of way.

Another benefit provided by the EAS is that it may remind users how to yield to oncoming emergency vehicles.

Yet another benefit provided by the EAS is that it may provide consumers with a discount on their automobile insurance.

Still yet another benefit provided by the EAS is that it may allow real-time interactive mapping applications to know the location of an accident or other emergency situation to re-route traffic away from such locations.

### BRIEF DESCRIPTION OF THE DRAWINGS

The aforementioned and related features and benefits of the present invention will become better understood and appreciated by those or ordinary skill in the art upon review of the following detailed description of the invention, in conjunction with the following drawings, where like numerals represent like elements, in which:

FIG. 1 is a schematic illustration of an emergency alert system and network, in accordance with an exemplary embodiment of the present invention;

FIG. 2 is a schematic illustration of a user or client device including a emergency alert application for use with the emergency alert system according to an exemplary embodiment of the present invention

FIG. 3 is a schematic illustration of a map presenting an intersection where an emergency situation may be occurring according to an exemplary embodiment of the present invention; and

FIGS. 4-5 are flowcharts illustrating a method of using the emergency alert system and network in accordance with an exemplary embodiment of the present invention.

### DETAILED DESCRIPTION OF INVENTION

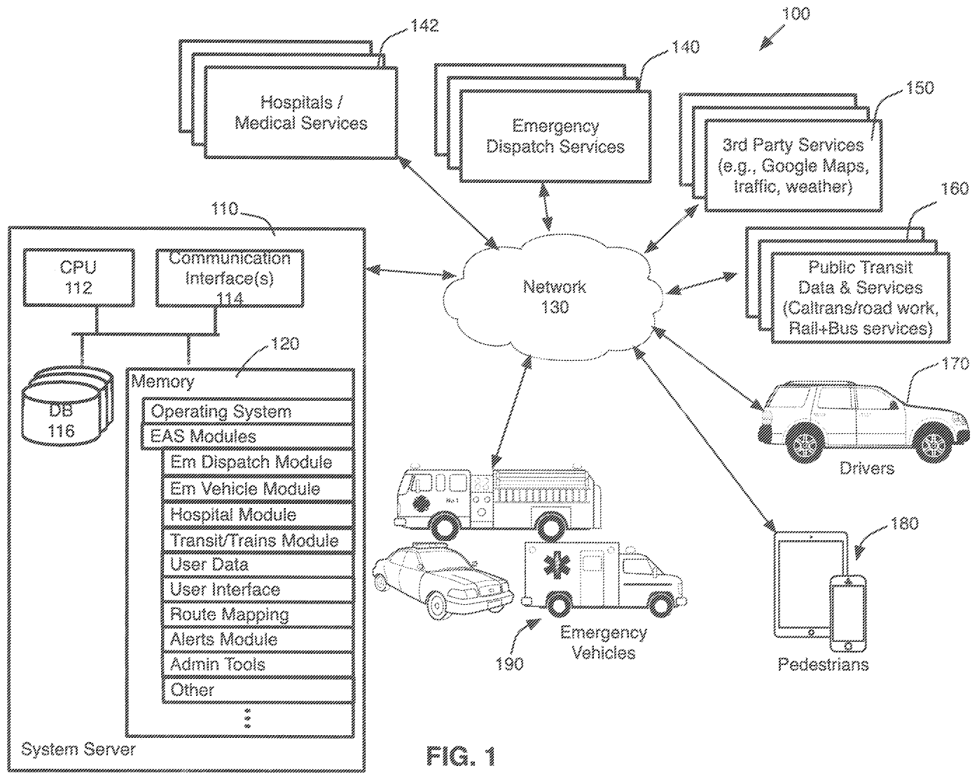

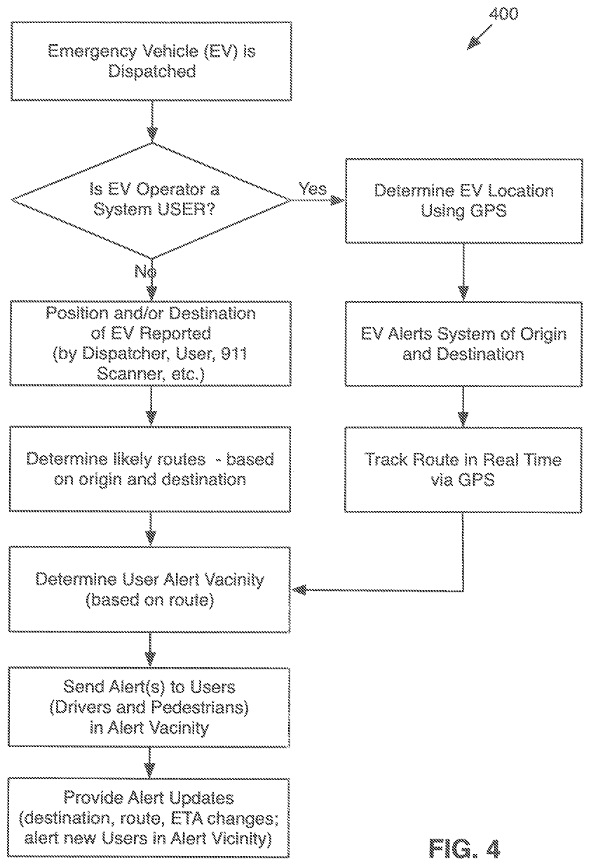

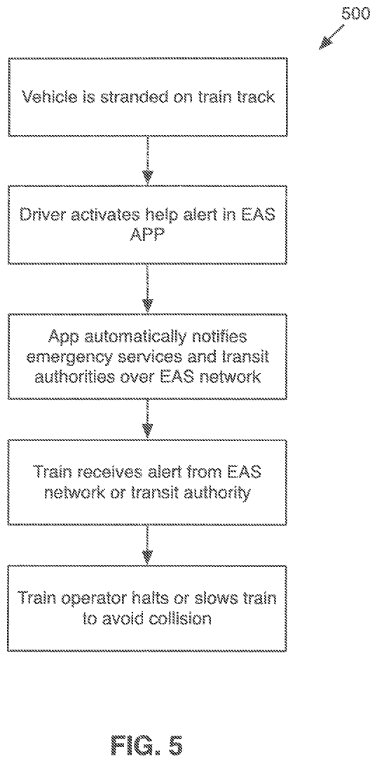

An exemplary embodiment of the present invention will now be described with reference to FIGS. 1-5. In the following description, for purposes of explanation, numerous examples and specific details are set forth to provide a thorough understanding of the present invention. It will be evident, however, to one skilled in the art that the present invention may include some or all of the features in these examples alone or in combination with other features described below and may further include modifications and equivalents of the features and concepts described herein.

Referring to FIG. 1, an emergency alert system (EAS) 100 may include a computer system or server 110 having a central processor 112 to control overall operation; a communication interface 114 for communicating over a network 130 and/or with other systems, services, or users; a database for storing data; and a memory including application modules and instructions, including for example an operating system and a number of EAS System modules, e.g., as shown in FIG. 1 and for providing the features and functions described herein.

The computer system 110 represents a generic platform that includes components that may be in a server or another computer system. The computer system 110 may be a single system or server, a distributed system, one or more controllers or one or more cloud services. The computer system 110 may execute, by a processor or other hardware processing circuit, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

System server 110 may communicate over a network 130, e.g., the Internet, cellular network, a local area network, a wide area network, a distributed network and/or other wired or wireless network or combination of networks using any desired communication protocols, with other devices, subsystems, and services. For example, emergency dispatch services 140 may provide information regarding the dispatch, destination, route, identification, route, and location of a first vehicle, for example, an emergency vehicle 190. Theses emergency dispatch services 140 may be maintained and operated by municipal, county, state or national monitoring and messaging services. In some embodiments, system server 110 may also communicate with and/or transmit messages and/or alerts to or through such emergency dispatch services, e.g., to alert dispatchers and or emergency vehicle operators of the location of users-drivers 170 who may be in the path of a second vehicle and/or need assistance.

In some embodiments, one or more third party databases and services 150 may also be used to provide information to the EAS 100, for example real-time mapping information (Google Maps, Apple Maps, etc.), real-time traffic information (Google Traffic, INRIX, Waze, or other traffic services), weather information, and/or any other desired information or data available over the Internet or a network 130.

In some embodiments, the EAS 100 may include information services and systems 160 regarding mass transit, road and rail systems, for example Caltrans (or other municipal, state or local road authority), train or rail services, bus services, taxi services, rideshare services, etc. For example, Caltrans may provide information regarding road work or road closures that may affect emergency response routes. Rail and bus services (and associated networks) may provide train or bus route information and location, and/or a means for communicating with operators of trains, buses, and other such vehicles, e.g., to alert them of users-drivers 170 who may be stranded along a rail or bus route.

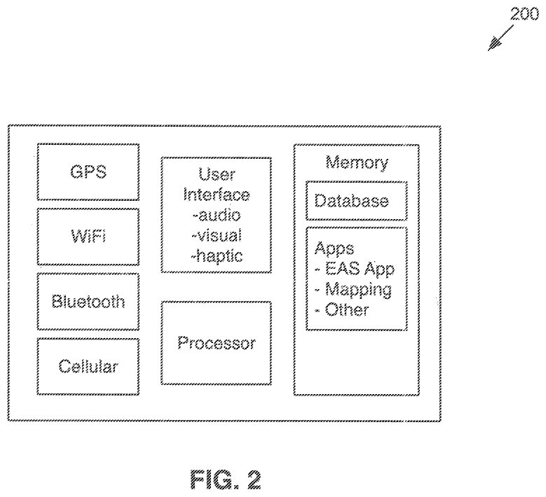

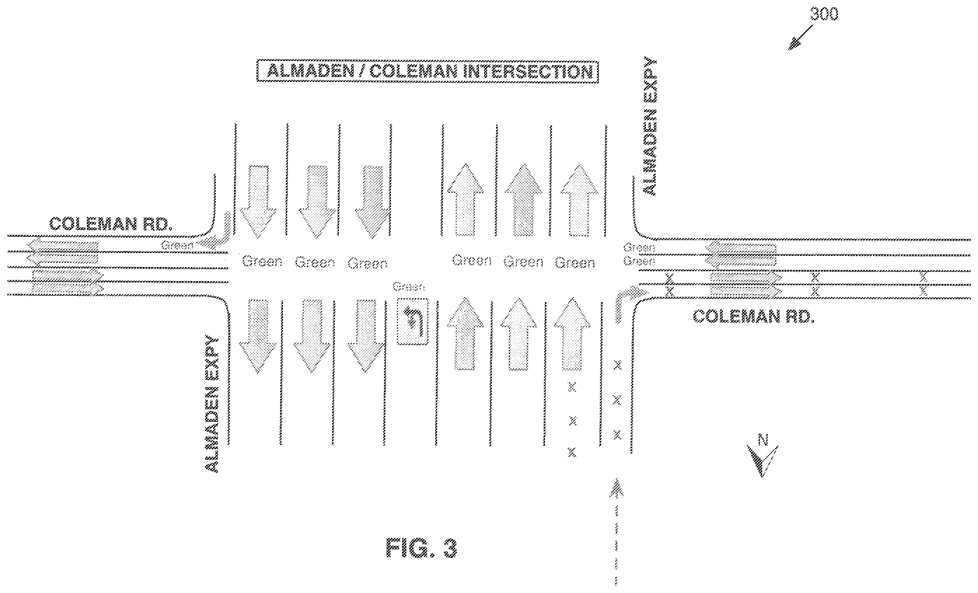

Drivers in this example may be passenger vehicle 170 drivers having a mobile or client device 200 (FIG. 2) running an EAS App as further described herein. Such app may communicate with the EAS modules in system server 110, e.g., to perform functions such as user registration and providing user alerts of approaching emergency vehicles, trains, etc. In some embodiments, the EAS App provides user with intersection maps and other alerts as described below with respect to FIG. 3. In some embodiments, the EAS App and/or associated hardware (e.g., GPS device, communication device, etc.—for example as shown in FIG. 2), may be installed or integrated within the driver's vehicle 170, for example, control system, communication system or display screen.

In some embodiments, other users may be pedestrians 180, e.g., each of whom may have a client or mobile device (for example a smart phone, tablet, laptop, or other portable phone or computing device) 200 capable of executing an EAS App and providing alerts and information to the user.

Emergency vehicles 190 may include any emergency response vehicle and/or vehicle operator, including for example fire trucks, paramedics, police vehicles, ambulances, highway patrol, sheriff, etc. In some embodiments, users may also include train conductors/drivers, bus operators, and other operators of mass transit vehicles.

### Example Use: Emergency Vehicle Alerts

FIG. 3 is a schematic illustration of a vehicle intersection demonstrating a method of alerting drivers of non-emergency or secondary vehicles 170 to the presence of an emergency vehicle 190 in the area. In some embodiments, such alerts may be delivered to drivers and/or pedestrians client devices 200 who are subscribers of a mobile application (also referred to herein as “users”) (e.g., an Emergency Alert System, or EAS Application, also referred to herein as the “App” as described herein), which may use audio and/or visual alerts to notify users, present in non-emergency vehicle(s) 170 of an approaching emergency vehicle 190.

In this example, briefly referring to FIG. 3, a fire truck or other emergency response vehicle 190 is traveling to the scene of a fire, accident or other emergency. Depending on the location of the emergency, the quickest route to the emergency location may be determined, e.g., by an emergency response navigation system using GPS location of the vehicle 190 and mapping information/application, e.g., such as Google Maps, Apple Maps, or other map or navigation application. The route may be used by an EAS System 100, for example to alert other drivers 170 of the path and lanes that the emergency vehicle 190 is traveling so that such drivers or non-emergency vehicles 170 may stay clear of the route.

For example, referring briefly to FIG. 3, an emergency vehicle 190 approaching the intersection of Almaden Expressway and Coleman Avenue has a planned route to travel south on Almaden and turn right on Coleman, e.g., as indicated by the dashed red line and red “x” marks. In some examples, the emergency vehicle 190 may be a half mile, a mile, or further away from the intersection when an alert is sent to vehicles 170 in the vicinity of the intersection to stay clear of the right southbound lane of Almaden and the right two eastbound lanes of Coleman. In some embodiments, in response to the emergency vehicle's route, EAS apps on all user devices 200 in the vicinity may produce an alert to warn drivers and/or pedestrians in the area of the approaching vehicle and to stay clear of the right one or two lanes of the emergency vehicle's route. For example, an audio alert (e.g., a tone, siren, or other sound) may emit from the mobile device (or in some embodiments, an device installed in passenger vehicles), and/or a map showing the route may appear on the screen of the device 200. In some embodiments, spoken instructions may be delivered to instruct the driver on how to safely avoid the path of the approaching emergency vehicle. (e.g., “Ambulance approaching southbound Almaden Expressway, move to the center or left lane”, or “Stay clear of right lane for approaching emergency vehicle”, etc.). In some embodiments, an intersection map having features as shown in FIG. 3, such as symbols to indicate the path of an emergency vehicle and/or resulting lane restrictions (e.g., red “X” symbols as shown in the example figure). In some embodiments, the EMS App will terminate an ongoing call to provide a user with audible notice of a nearby emergency situation.

In some embodiments, an EAS App of a user's client device 200 or vehicle will only emit an alert if the user is traveling in a particular direction with respect to the approaching vehicle and/or its route. In such embodiments, a user's mobile device 200 and/or vehicle associated with the EAS App may include a GPS system or other location system capable of determining the user's location and direction of movement, and alerts may be delivered depending upon such information. For example, with reference to the example map of FIG. 3, in some embodiments, vehicles traveling northbound on Almaden and/or eastbound on Coleman may not receive an alert (e.g., unless they are in the left hand turn lane, or other conditions exist), while user's traveling southbound on Almaden and/or westbound on Coleman may be receive an alert.

In some embodiments, other drivers who are not in the route, path or lane of the emergency vehicle may be instructed to stay in their current lane, or maintain or adjust speed, or allow other vehicles to merge, or other messages or alerts as appropriate to assist or avoid interfering with the vehicle path. In some embodiments, only those vehicles in the path of a fire truck or other emergency vehicle are alerted.

In some embodiments, referring again to FIG. 3, if a driver making a U turn or left turn on Coleman he or she can still do that without any problem. If the light is green-he/she will get a green light to turn. Same for those going southbound on Almaden Expressway.

In some embodiments, one or more lanes along an emergency vehicle's route displayed on the mobile application will show an “X” or other indicia even when the stoplight light is green. When the emergency vehicle 190 passes, for example, the “X” will be removed and/or other “Go” or “Open” symbols may be used to indicate that the lane is reopened and safe to use. In some embodiments, the system is a redundant system, with multiple servers and/or distributed systems interfacing with users and capable of sending emergency signals.

### Example Use: Railroad Crossing

In any given daylight moment in America, there are 660,000 people behind the wheel who are checking their devices instead of watching the road. 21% of the fatalities and about 50% of the serious injuries on U.S. roads have involved intersections. And the injuries are usually to pedestrians and other drivers, not the driver running the red light.

However a report in the New York Times listed along with marked crossings, users can expect audio and visual alerts when the app's navigation feature leads them toward a railroad crossing.

About every three hours, a person or a vehicle is hit by a train. Flashing red signals, gates, or other devices that warn drivers of a coming train does not exist at all rail road crossing, and some of the railroad crossings are not working properly, so even if they exist accident might happen. In some embodiments, an EAS system (e.g., system 100) includes train routes and location information to let drivers know when they are close to a railroad crossing and when a train is approaching. Such features may provide a redundant safety system in the event that railroad crossing indicators are not working properly

For example, in an accident in New York, at least seven people, the driver of a car and six of the train passengers, were killed and others were injured after a Metro-North commuter train struck a Jeep on the track. The gates came down on top of the vehicle, which was stopped on the tracks. Possibly the driver tried to race the train or beat the railroad crossing gate and became stuck. In any event, if there was a system to alert the train's driver that there is a car or other vehicle stuck on the track, the driver might have been able to avoid it. Similarly, if the driver had known of the train's location earlier, he might not have been caught off guard by the sudden railroad crossing and have been able to avoid getting stuck. Thus, such type of accident may be avoided in case that both the vehicle driver and the train operator are users of an EAS App as described herein.

In some embodiments, GPS in a user's mobile device 200 or vehicle-installed EAS device will determine the location of the driver/user on a train or rail track (or in some embodiments, immobile in the path of an emergency vehicle) and connect with the proper local authority for help. For example, the central server 110 may include telephone numbers and/or other interfaces to communicate with the applicable rail service operators. In some embodiments, a user/driver will be provided with such contact information to alert authorities (e.g., without having to actively search for an 800 number, for example), and/or in some embodiments such alerts to authorities may be performed automatically. Also, in some embodiment, the EAS system 100 will alert a train operator (e.g., by showing a representation of a car on the track in the applicable location to a train operator/user of the EAS App) so the train(s) can slow down or stop in time to avoid a collision.

In some embodiments, systems and applications described herein may be used by first responders and other emergency personnel in the event of a dispatch system failure. For example, if a fireman/EMT/police officer is in trouble, they may use the application to send a notification to call for help and/or connect with other emergency personnel users through the system.

In some embodiments, example users of the system may include any of: drivers, pedestrians, police officers, fire fighters, paramedics/EMT/emergency medical services, fire fighters. In some embodiments, each user (and/or group of users) may have a different password and/or different permissions for accessing and using the system.

The foregoing detailed description of the invention illustrates various embodiments along with examples of how aspects of the systems may be implemented. The above examples and embodiments should not be deemed to be the only embodiments, and are presented to illustrate the flexibility and advantages of the systems as defined by the following claims. In the figures, similar symbols typically identify similar components, unless context dictates otherwise. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the sequence diagrams and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the diagrams, scenarios, and flow charts discussed herein, and these diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). Functional aspects described as modules need not be arranged or stored as a unit, and may include instructions, routines or program code distributed, stored and executed in any manner. The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, flash drives, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices. Similarly, while some processors, computer systems or servers are depicted for purposes of illustration as a single device or module, one skilled in the art will appreciate that the corresponding hardware and software components may be distributed among several computer systems, processors, servers, cloud services or other systems.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An emergency alert system, comprising:
a controller;
a communication interface; and
a memory, coupled to the controller and the communication interface, the memory including modules that when executed by the controller, cause the emergency alert system to:
receive real-time location information from one or more emergency vehicles,
determine a route to be traversed by the one or more emergency vehicles,
receive location information from one or more non-emergency vehicles,
determine the location of the one or more emergency vehicles and the one or more non-emergency vehicles intersect, and
send a warning signal to at least one of the one or more emergency vehicles and the at least one or more non-emergency vehicles.

2. The emergency alert system of claim 1, wherein the controller comprises at least one of a processor, an application specific integrated circuit, a distributed processor system and a carrier wave signal.

3. The emergency alert system of claim 1, wherein the memory further includes instructions that when executed by the controller further cause the communication interface to receive dispatch data from a dispatcher.

4. The emergency alert system of claim 3, wherein the dispatcher further includes a transceiver to transmit emergency vehicle destination information to the one or more emergency vehicles.

5. The emergency alert system of claim 4, wherein the communication interface receives the emergency vehicle destination information from the dispatcher.

6. The emergency alert system of claim 5, wherein the memory further includes instructions that when executed by the controller, causes the controller to determine the intersection point between the at least one or more emergency vehicles and the at least one or more non-emergency vehicles.

7. The emergency alert system of claim 6, further including the communication interface receiving the intersection point data from the dispatcher.

8. The emergency alert system of claim 7, wherein the memory further includes instructions that when executed by the controller, causes the controller to send an alert signal to each of the at least one of the one or more emergency vehicles and the at least one of the one or more non-emergency vehicles.

9. The emergency alert system of claim 8, wherein the alert signal is an audible signal which alerts a driver of the emergency vehicle of a potentially dangerous situation at the intersection point.

10. The emergency alert system of claim 8, wherein the alert signal is an audible signal which alerts a driver of the non-emergency vehicle of a potentially dangerous situation at the intersection point.

11. The emergency alert system of claim 8, wherein the alert signal causes a transceiver in the at least one of the one or more non-emergency vehicles to discontinue any audio or video transmissions and present the audible signal to the driver of the at least one or more of the non-emergency vehicles.

12. The emergency alert system of claim 8, wherein upon the communication interface receiving the alert signal, the instructions causes the controller to send a haptic control signal to the at least one of the non-emergency vehicles to initiate a haptic response within the at least one or more non-emergency vehicles.

13. The emergency alert system of claim 6, wherein the intersection point is determined at least in part by global position data corresponding to the at least one of the one or more emergency vehicles and the at least one or more of the non-emergency vehicles.

14. An emergency alert system, comprising:
a controller;
a transceiver; and
a memory coupled to the controller, the memory storing application instructions, which when executed by the controller, cause the controller to:
receive an alert signal, the alert signal indicating that an emergency vehicle is near the location of the controller,
discontinue any transceiver activity and presenting the alert signal to a user, wherein the alert signal indicates that an emergency vehicle is in close proximity to the controller.

15. The emergency alert system of claim 14, wherein the memory stores application instructions, which when executed by the controller, causes the controller to send location information to a third party receiver.

16. The emergency alert system of claim 15, further including a global position module operative to determine the location information of the transceiver and send the location information of the transceiver to the third party receiver.

17. The emergency alert system of claim 14, further including a haptic controller and wherein the memory stores application instructions, which when executed by the controller, causes the haptic controller to activate upon receipt of the alert signal.
